(19) United States
(12) Patent Application Publication
(10) Pub. No.: US 2012/0051237 A1
(43) Pub. Date: Mar. 1, 2012

(54) Method to schedule IEEE 802.11 channel as a QoS enabled GPRS supplementary high speed data channel

(76) Inventors: Baohong Sun, Ottawa (CA); Shiquan Wu, Ottawa (CA)

(21) Appl. No.: 13/137,466

(22) Filed: Aug. 18, 2011

Related U.S. Application Data
(60) Provisional application No. 61/344,578, filed on Aug. 25, 2010.

(51) Int. Cl. H04W 24/00

(52) U.S. Cl. 370/252

(57) ABSTRACT

This invention discloses a method of seamlessly integrate IEEE 802.11 MAC/PHY into GPRS system so that 802.11 channel can be scheduled within GPRS system as a QoS guaranteed service channel. The invented method comprises 1) enhanced GPRS signaling through GPRS control channel to coordinate 802.11 MAC/PHY, 2) GPRS layer 2 RLC PDUs encapsulation in 802.11 MAC, 3) 802.11 timing aligned with GPRS control frame. The invented method will enable GPRS system to control and manage 802.11 radio links to offer QoS guaranteed broadband wireless service.

### CLAIM OF PRIORITY

This patent application claims the benefit of priority from U.S. Provisional Patent Application No. U.S. 61/344,578 filed on Aug. 25, 2010. This application incorporates by reference the entire disclosure of U.S.A. Provisional Patent Application No. U.S. 61/344,578.

### 1. FIELD OF THE INVENTION

The present invention discloses a method, to seamlessly integrate IEEE (Institute of Electrical and Electronics Engineers) 802.11 MAC (Medium Access Control)/PHY (Physical) into GPRS (General Packet Radio Services) system. The method comprises 1) enhanced GPRS signaling through GPRS control channel to coordinate 802.11 MAC/PHY, 2) GPRS layer 2 RLC (Radio Link Control) PDUs (Packet Data Unit) encapsulated in 802.11 MAC, 3) 802.11 frame transmission aligned with GPRS control frame. With this disclosed method, the GPRS system will be enabled to offer high speed mobile data services.

### 2. BACKGROUND OF THE INVENTION

GPRS, as an evolution of GSM (Global System for Mobile Communication), is a TDMA (Time Division Multiple Access) based digital wireless communication standard designed to support low speed wide area wireless data services. GPRS makes use of TBF (Temporary Block Flow) procedure to allocate downlink or uplink time slots for data transmission. For GPRS, there are 4 coding schemes defined, for EGPRS (enhanced GPRS), there are 9 coding schemes defined. The transmitted IP (Internet Protocol) packets are encapsulated through LLC (Logical Link Control) layer into RLC/MAC data blocks for over the air transmission in assigned time slots.

IEEE 802.11 is a popular local area wireless network standard and widely deployed in the world. Mostly, 802.11 products work in 2.4 GHz and 5.8 GHz frequency bands. IEEE 802.11 station or client usually goes through authentication, authorization, association procedure to associate to an AP (access point); makes use of request to send (RTS), clear to send (CTS) to reserve the radio resource before packet transmission.

If an IEEE 802.11 station has found an AP and decides to associate to it, it will go through authentication procedure to exchange information with AP to obtain permission.

When the station is authenticated, it will start association procedure to exchange capabilities. Upon the association procedure completes, station is allowed to transmit and receive 802.11 data frames to/from the AP.

To transmit a packet, the IEEE 802.11 station needs to sense if the channel is idle. The station transmit the RTS short control packet first, if the channel idle, the peer station respond with a CTS short control packet, means the channel is available, the station starts transmit the data packet. The transmitted IP packets are adapted through LLC layer into IEEE 802.11 frames for over the air transmission.

In current practice, there are two GPRS WLAN (Wireless Local Area Network) inter-working architectures have been developed: GPRS WLAN tight coupling architecture and loose coupling architecture.

For the tight coupling architecture, typical access points are deployed to form a distributed WLAN network, which connects through GPRS inter-working function (GIF) to SGSN (Serving GPRS Supporting Node) via Gb (interface between GPRS base station subsystem and SGSN) interface. The GPRS network treats WLAN network as an independent routing area. The IEEE 802.11 chip built into the user terminal needs to perform the Authentication Procedure, Association Procedure, RTS and CTS procedure, before exchange any data frame with an AP. After association and authentication procedure, all the ongoing GPRS signaling will be exchanged through 802.11 radio frames therefore it is complicate and unreliable. WLAN adaptation function (WAF) is defined in user terminal and GIF side to facilitate LLC packet data unit (PDU) encapsulation and transmission in 802.11 frame formats.

For the loose coupling architecture, the typical access points form a WLAN network, which connects to GPRS packet core network though Gi (interface between Gateway GPRS Support Node and the external Public Data Network) interface, the data traffic does not even go through GPRS core network therefore WLAN and GPRS are separate.

### 3. SUMMARY OF THE INVENTION

The present invention discloses a method, to seamlessly integrate 802.11 MAC/PHY capabilities into GPRS system. The method has the following characteristics: 1) an enhanced GPRS signaling through GPRS control channel to operate 802.11 MAC/PHY, 2) GPRS RLC PDUs encapsulation in 802.11 MAC, 3) 802.11 data framing aligned with GPRS control frame.

The present invention replaces the 802.11 control procedures such as authentication, association, RTS/CTS procedure with enhanced GPRS signaling and procedures. The enhanced GPRS signaling messages exchanged via GPRS control channel are intended to control 802.11 MAC and physical layers to perform data frame transmission, as well radio link establishment, tear down, reconfiguration and handover.

Temporary Block Flow (TBF) is a unidirectional logical connection between two GPRS entities to assign radio resources, i.e. time slots in GPRS. Upon a TBF established, the time slots are assigned in that direction to facilitate RLC/MAC radio block transmission.

Packet time slot reconfigure message is a GPRS control signaling message to assign uplink or downlink radio resources in terms of time slots and transmission duration. Frequency information is included as information element in the message, which will be valid until a new assignment received by the terminal or each TBF of the terminal is terminated.

The present invention discloses how to reuse TBF mechanism to schedule 802.11 radio resources, specify 802.11 frame transmission start time, duration and channel release etc.

One embodiment of the invention proposes simultaneous existence of specific TBF for 802.11 frame transmission and GPRS TBF for GPRS frame transmission.

Another embodiment of the invention uses the enhanced packet time slot reconfigure message, through GPRS control channel to schedule 802.11 radio resources, reconfigure or handover the 802.11 radio link, specify 802.11 frame transmission start time and duration which aligns with GPRS control frame.

Yet another embodiment of the invention proposes to encapsulate GPRS RLC PDUs into 802.11 MAC for 802.11 frame transmission.

In one embodiment, the enhanced GPRS signaling message and procedures are used to control 802.11 transceivers to perform neighbor AP and frequency measurement reports in real time.

In other embodiment, the enhanced GPRS signaling message and procedure are used to perform 802.11 block error measurement periodically and feedback the other end of communication in real time during 802.11 data frame transmission.

The current invention proposes a fall back mechanism, upon 802.11 radio link establishment fail or time out, GPRS radio link will be established for continuous data communication.

The current invention proposes to embed terminal 802.11 transceiver radio capability information into the enhanced GPRS attach complete message. Terminal 802.11 capabilities may include transmission power limit, antenna gains, coding and modulation schemes, carrier frequencies, bandwidth etc.

### 4. DESCRIPTION OF DRAWINGS

The present invention will be further understood from the following reference drawings and further detailed embodiments descriptions.

FIG. 1 illustrates GSM/GPRS multi-frame, Super-frame and Hyper frame structure

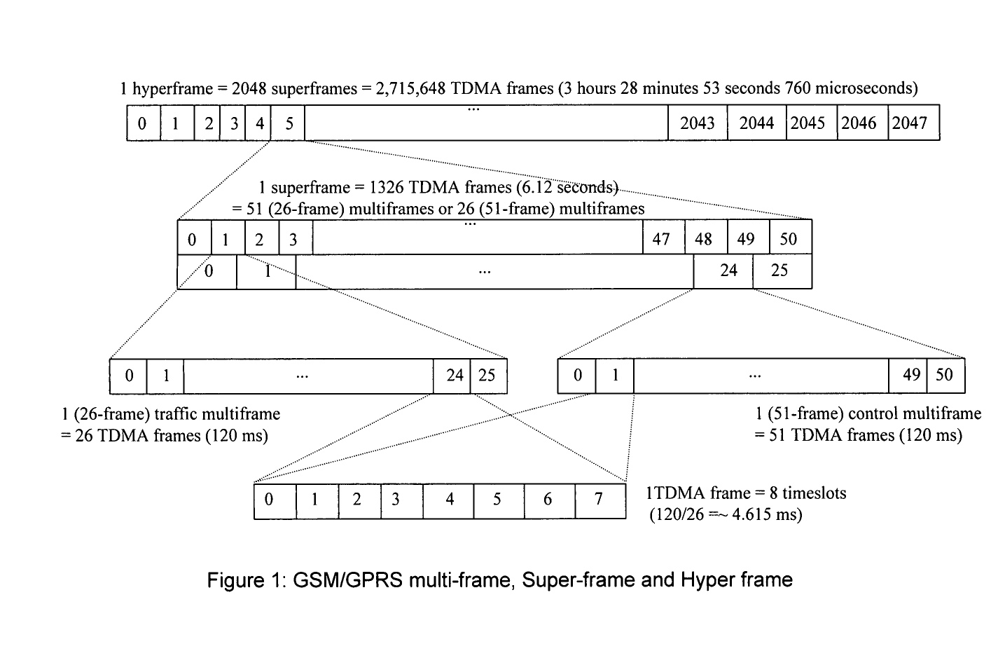

FIG. 2 describes GPRS RLC/MAC data block structure

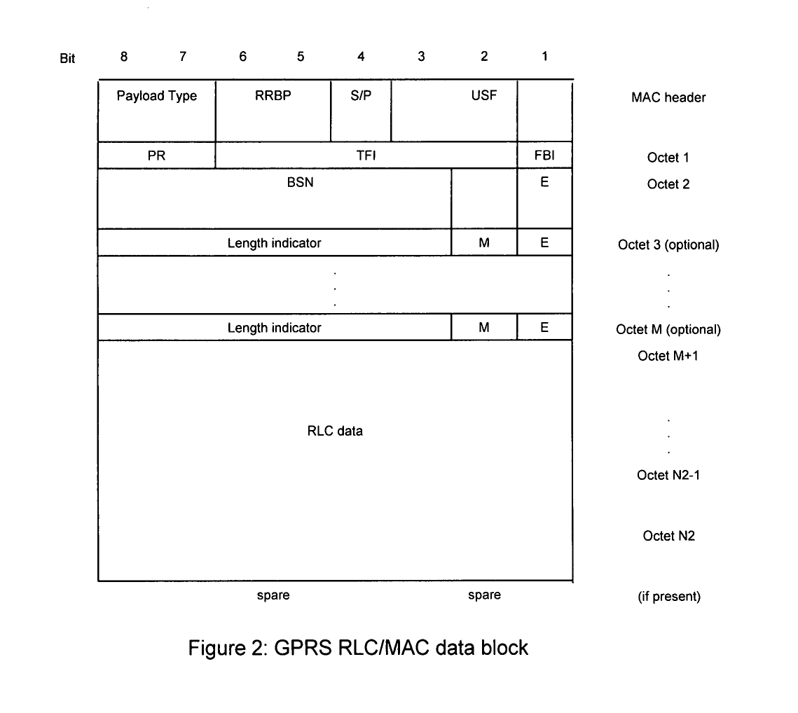

FIG. 3 illustrates GPRS CS-1 to CS-3 radio block

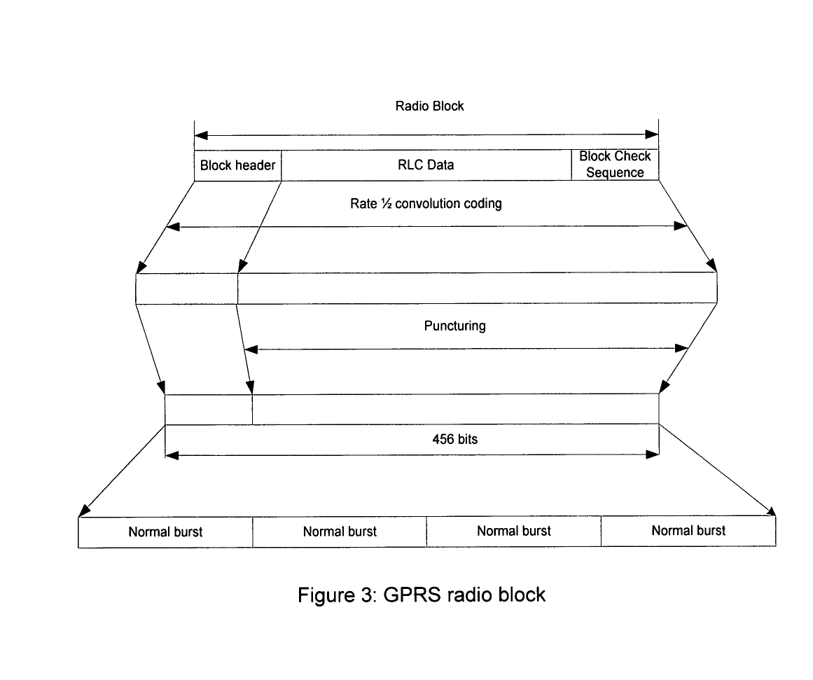

FIG. 4 provides an example of network

FIG. 5 describes Access point architecture

FIG. 6 describes terminal architecture

FIG. 7 presents radio resource management architecture

FIG. 8 illustrates downlink TBF establishment steps for 802.11

FIG. 9 illustrates Uplink TBF establishment steps for 802.11

FIG. 10 describes enhanced packet time slot reconfigure message flow to reconfigure 802.11 radio link

FIG. 11 describes enhanced packet timeslot reconfigure message flow to handover 802.11 radio link

### 5. DETAILED DESCRIPTION OF THE INVENTION

Various exemplary embodiments are summarized in the following paragraphs. Certain simplifications and omissions are made to highlight some aspects of the exemplary embodiments which will not limit the scope of the invention. Detailed descriptions of a preferred exemplary embodiment are adequate to those skilled persons in the art to make and to use the inventive system concepts and methods.

The present invention discloses a method, to seamlessly integrate 802.11 MAC/PHY into GPRS system. The method has the following characteristics: 1) enhanced GPRS signaling through GPRS control channel to operate 802.11 MAC/PHY, 2) GPRS RLC PDUs encapsulation in 802.11 MAC protocol 3) 802.11 data framing aligns with GPRS control frame. Different from IEEE 802.11, the disclosed method replaces 802.11 control procedures such authentication, association, RTS/CTS with enhanced GPRS signaling messages. Therefore 802.11 channels can be used with QoS guarantee.

Different from 3GPP GPRS system, the proposed method splits GPRS RLC layer from 3GPP MAC Layer and apply it on top of 802.11 MAC layer, i.e. the proposed system can encapsulate RLC PDUs into 802.11 MAC frames.

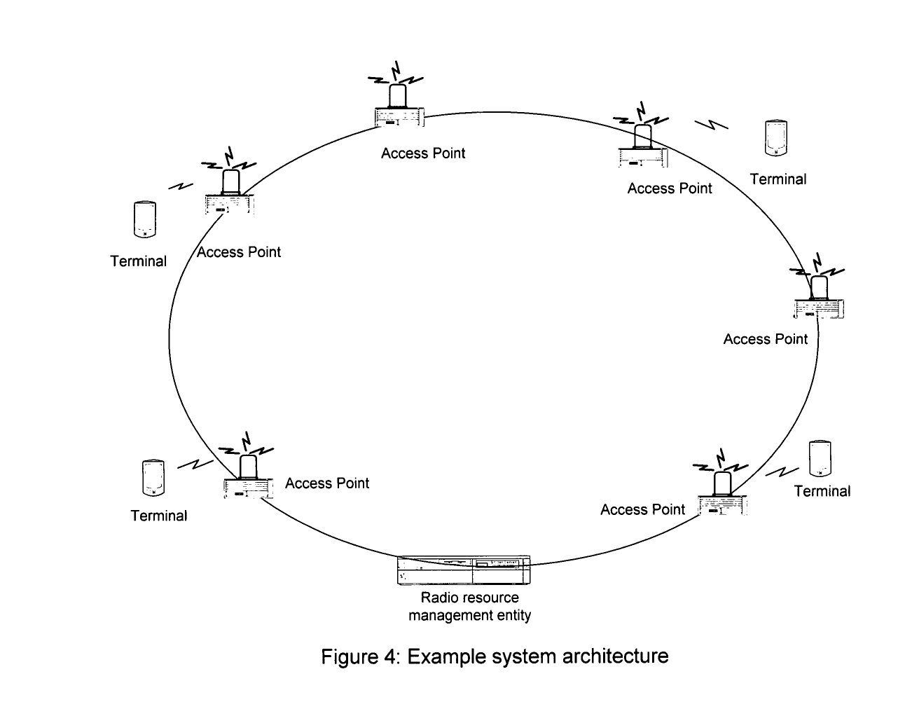

There is an illustrate system which implements the disclosed method (refer to FIG. 4). The exemplary system comprises an array of access points (AP) distributed in the field, a radio resource management entity which connects to all the APs via wires or other means and terminals.

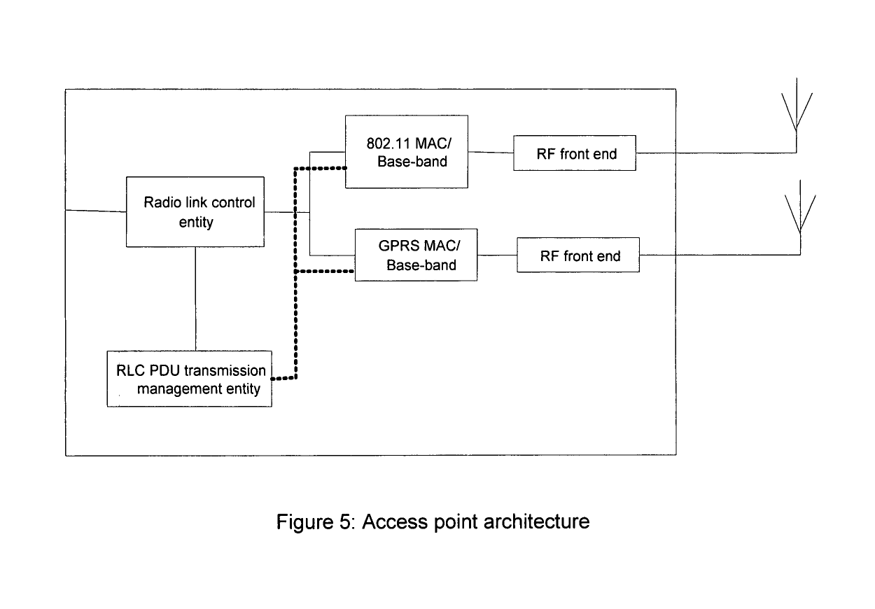

The exemplary system AP comprising: the antenna system; harmonized GPRS and 802.11 transceivers; a radio link control entity; a RLC PDU transmission management entity; refer to FIG. 5.

The radio link control entity is responsible for radio link establishment, maintenance, reconfiguration and handover. The RLC PDU transmission management entity is responsible for encapsulate the RLC PDUs into either GPRS MAC or 802.11 MAC.

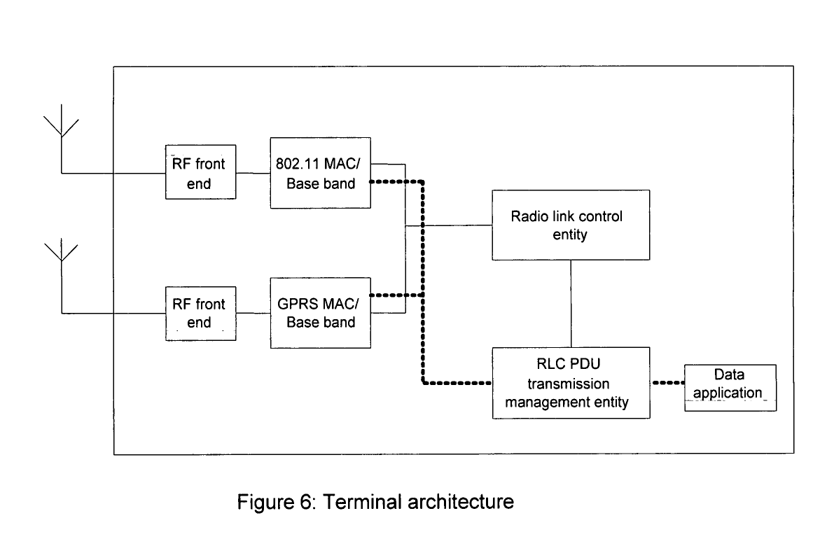

The terminal of the exemplary system comprising: the antenna; harmonized GPRS and 802.11 transceivers; a radio link control entity; and an RLC PDU transmission management entity; refer to FIG. 6.

The radio link control entity is responsible for radio link establishment, maintenance, reconfiguration and handover. The RLC PDU transmission management entity is responsible for encapsulate the RLC PDUs into either GPRS MAC or 802.11 MAC.

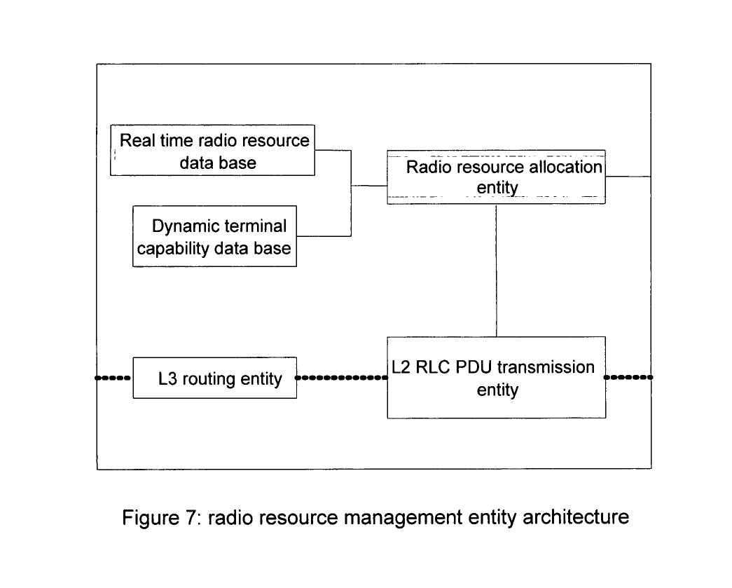

The exemplary system radio resource management entity comprising: a real time radio resource data base; a terminal capability data base; a radio resource allocation entity; L2 RLC PDU transmission entity and L3 routing entity; refer to FIG. 7.

The real time radio resource database may contain all the information such as central frequency, channel bandwidth, noise level and GPS location. The database is updated by the terminal by 802.11 link measurements.

The terminal capability database contains GPRS-802.11 radio capability information, its current battery level and the attached AP identity etc.

Upon GPRS transceiver radio on, the terminal performs GPRS attachment procedure to attach to an AP. Upon completion of the attachment, terminal sends GPRS attach complete message to AP radio link control entity. The terminal embed its 802.11 radio capability information such as supported frequency, channel bandwidth, maximum Tx power, modulation and coding scheme into GPRS attach complete message. The AP radio link control entity forwards the received terminal radio capability information to the terminal capability data base, which associates them with the attached AP identity as a record.

From time to time, the AP radio link control entity periodically instructs the terminal 802.11 module to perform neighbor AP and frequency measurement. The terminal report back through GPRS control channel the measurement result comprising the central frequency, channel bandwidth, signal strength level and geo-location. The radio link control entity forwards the received measurement result to the real time radio resource data base.

Each terminal periodically reports its battery level through GPRS control channel. The access point radio link control entity forwards the received terminal battery information to the terminal capability data base.

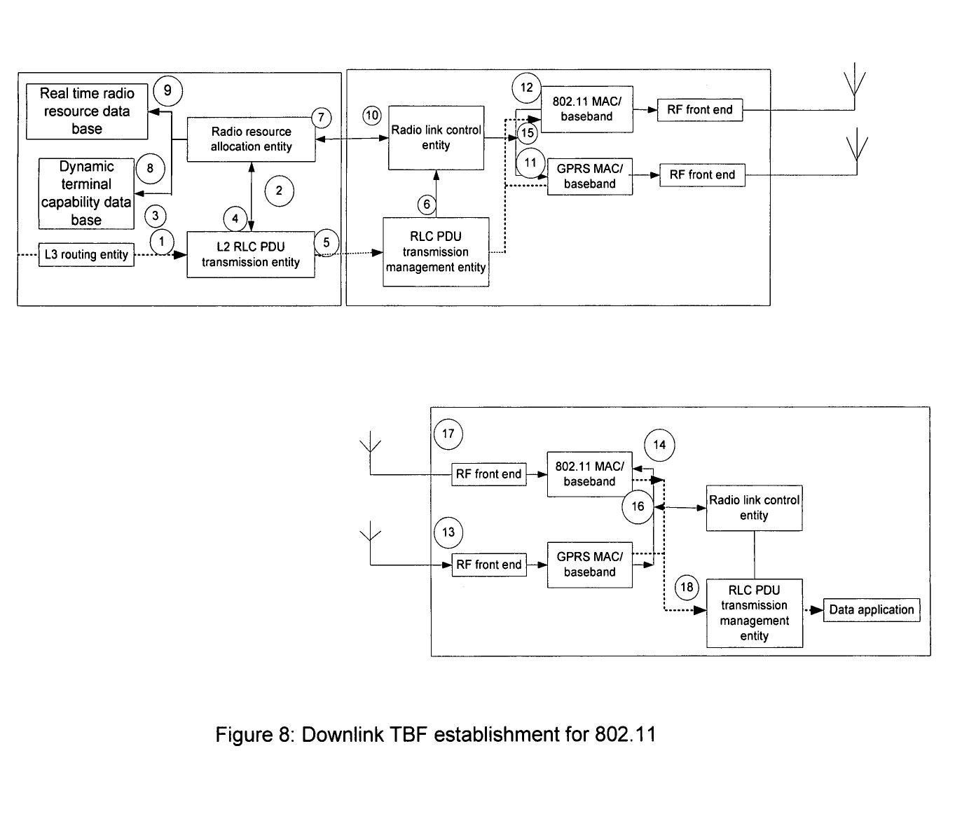

Referring to FIG. 8, upon receives a data packet which is addressed to a specific terminal \textcircled{1}, the L2 RLC PDU transmission entity query radio resource allocation entity \textcircled{2}, which further query dynamic terminal capability data base for the terminal currently attached AP identity \textcircled{3}. The returned AP identity will be forwarded to L2 RLC PDU transmission entity \textcircled{4}. With the AP identity received, the L2 RLC PDU transmission entity forwards accordingly the received RLC PDUs to the terminal that is attached AP RLC PDU transmission management entity \textcircled{5}. The AP RLC PDU transmission management entity will query radio link control entity if a radio link presence \textcircled{6}. If there is no radio link available, the AP radio link control entity will query radio resource allocation entity to request the 802.11 radio resource \textcircled{7}. The radio resource allocation entity will query dynamic terminal capability data base for the terminal 802.11 radio capabilities and battery level \textcircled{8}, query real time radio resource data base for the available and allowed 802.11 radio resource \textcircled{9}, then decide whether to assign the 802.11 radio resource. The radio resources comprise: frequency, channel bandwidth, coding schemes, modulation schemes, initial transmission power etc. \textcircled{10}. The AP radio link control entity will go through standard GPRS procedure to establish a specific downlink TBF \textcircled{11}. The 802.11 radio link configuration information contained in the specific TBF establishment message comprise: frequency, channel bandwidth, coding scheme, modulation, initial transmission power, 802.11 frame transmission start time aligned with GPRS control frame.

Upon the specific TBF establishment message being sent, the AP radio link control entity will configure its 802.11 transceiver according to the specific TBF message \textcircled{12}. Upon the terminal receives from GPRS control channel the specific TBF message \textcircled{13}, the terminal radio link control entity will configure its 802.11 transceiver accordingly \textcircled{14}. At a specified GPRS control frame time, the AP radio link control entity will instruct the 802.11 module to turn on and to transmit the 802.11 frames \textcircled{15}. At the specified GPRS control frame time, the terminal radio link control entity will instruct the 802.11 transceiver to turn on the 802.11 receiver module \textcircled{16} and demodulate/decode the message \textcircled{17}. The received 802.11 frame will be passed on to the terminal RLC PDU transmission management entity \textcircled{18} for further processing.

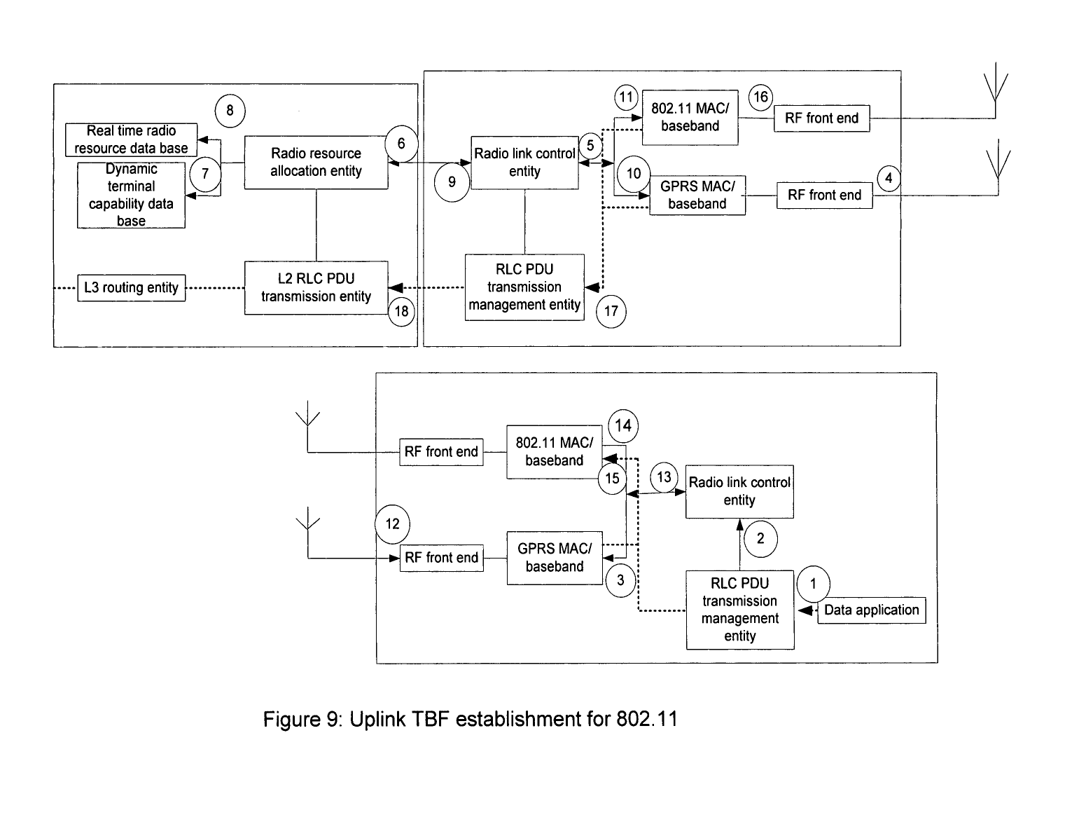

Refer to FIG. 9, upon a data packet received from terminal data application \textcircled{1}, the RLC PDU transmission management entity will query terminal radio link control entity if there is a radio link exist \textcircled{2}. If there is no radio link available, the terminal radio link control entity will send a channel request through GPRS control channel \textcircled{3}. Upon the channel request received by the AP GPRS module \textcircled{4}, it will be forwarded to the AP radio link control entity \textcircled{5}. The AP radio link control entity will query radio resource allocation entity to acquire the 802.11 radio resource \textcircled{6}. The radio resource allocation entity will query dynamic terminal capability data base for the terminal 802.11 radio capability and battery level \textcircled{7}, query the radio resource data base for the available 802.11 radio resource \textcircled{8}, the 802.11 radio resources comprise: frequency, channel bandwidth, coding scheme, modulation, initial transmission power, etc. and return to the AP radio link control entity \textcircled{9}.

The AP radio link control entity will go through standard GPRS procedure to establish a specific uplink TBF \textcircled{10}. The 802.11 radio link configuration information will be included in the specific TBF establishment message which comprises frequency, channel bandwidth, coding scheme, modulation, initial transmission power, 802.11 frame transmission start time aligned with GPRS control frame.

Upon the specific TBF establishment message being sent to the terminal, the AP radio link control entity will configure its 802.11 transceiver according to the specific TBF message \textcircled{11}. Upon the terminal received from GPRS control channel the specific TBF message \textcircled{12}, it will be forwarded to the terminal radio link control entity \textcircled{13}. The terminal radio link control entity will configure its 802.11 transceiver accordingly \textcircled{14}. At the specified GPRS control frame time, the terminal radio link control entity will instruct the 802.11 transceiver to turn on the 802.11 radio module, start the 802.11 frame transmission \textcircled{15}. At the specified GPRS control frame time, the AP radio link control entity will instruct the 802.11 transceiver to turn on the 802.11 radio module, start the 802.11 frame receiving \textcircled{16}. The received 802.11 frame will be passed on to the AP RLC PDU transmission management entity \textcircled{17}, then forward to the L2 RLC PDU transmission entity towards the network \textcircled{18}.

In case of failure or 802.11 frame transmission time out, the AP radio link control entity will trigger a GPRS TBF for further data communication.

If simultaneous high speed downlink and uplink transmission needed, the AP radio link control entity may trigger a specific TBF for 802.11 downlink and a GPRS TBF for uplink and vise versus.

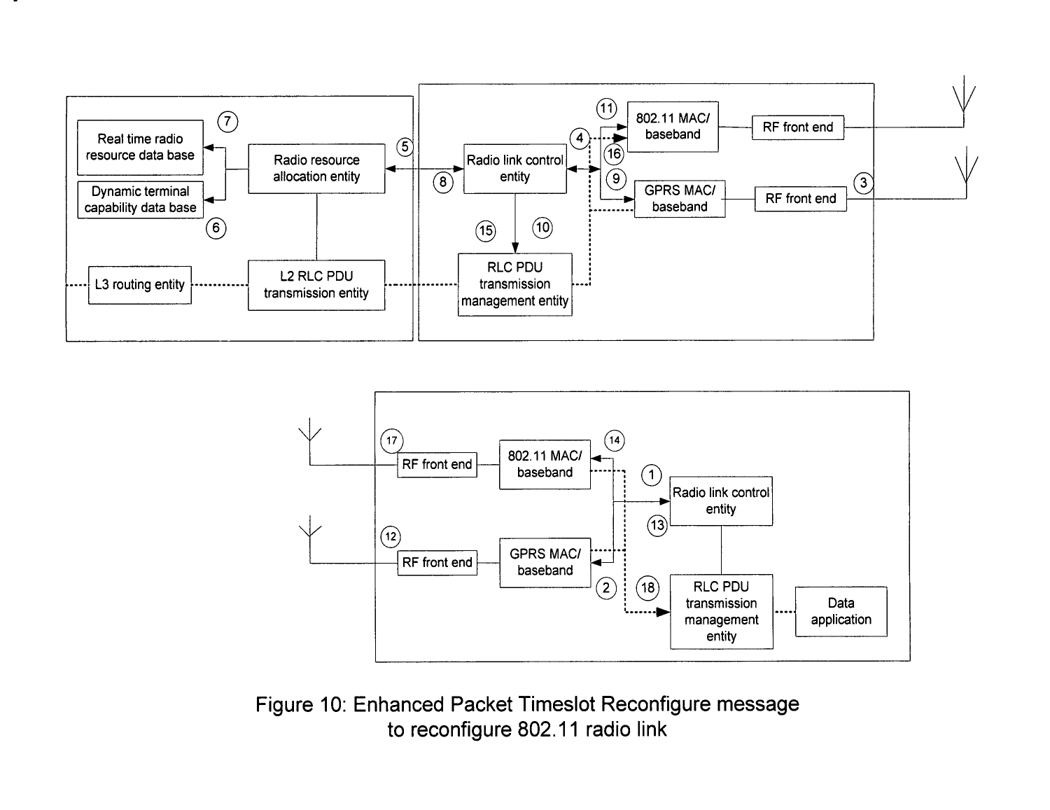

Refer to FIG. 10, the terminal 802.11 transceiver periodically measure 802.11 block error rate during downlink 802.11 frame transmissions, if the error rate is high for a period of time, the 802.11 transceiver will report to the terminal radio link control entity \textcircled{1}. Terminal radio link control entity will report to AP radio link control entity through GPRS control channel \textcircled{2}. Upon AP GPRS module receives \textcircled{3} the report, it will forward the report to AP radio link control entity \textcircled{4}. The AP radio link control entity will instruct to increase the transmission power. If still the problematic, the AP radio link control entity may decide to reconfigure the 802.11 radio link. The AP radio link control entity will query radio resource allocation entity for the available 802.11 radio resource \textcircled{5}. The radio resource allocation entity will query dynamic terminal capability data base for the terminal 802.11 radio capability and battery level \textcircled{8}, query real time radio resource data base for the available and allowed 802.11 radio resource \textcircled{7}, decide the new 802.11 radio resources comprise frequency, channel bandwidth, coding scheme, modulation, initial transmission power, and return to the AP radio link control entity \textcircled{8}. The AP radio link control entity will compose a specific packet time slot reconfigure message and send it to terminal through GPRS control channel \textcircled{9}.

Upon the specific packet time slot reconfiguration message being sent, the AP radio link control entity will instruct the RLC PDU management entity to suspend the RLC PDU transmission \textcircled{10}, suspend the current 802.11 frame transmissions, turn off the 802.11 radio module, and configure the 802.11 transceiver accordingly \textcircled{11}. When the specific packet time slot reconfiguration message received by the terminal GPRS transceiver \textcircled{12}, it will be forwarded to the terminal radio link control entity \textcircled{13}. The terminal radio link control entity will turn off the 802.11 radio module, configure the 802.11 transceiver accordingly, and turn on 802.11 radio module, ready to receive the from the new radio link downlink 802.11 frames \textcircled{14}. At the specified GPRS control frame, the AP radio link control entity instruct the RLC PDU transmission management entity to resume the RLC PDU transmission \textcircled{15}, turn on the 802.11 radio module, starts 802.11 frame transmission at the specified GPRS control frame time \textcircled{16}. Upon received the 802.11 frames received from the new radio link \textcircled{17}, the terminal 802.11 transceiver will forward them to the RLC PDU transmission management entity \textcircled{18}.

In case the 802.11 radio link reconfiguration failure or time out, the AP radio link control entity will try to resume the original 802.11 radio link. If it fails, the AP radio link control entity will fall back to a GPRS TBF for continuous data communication.

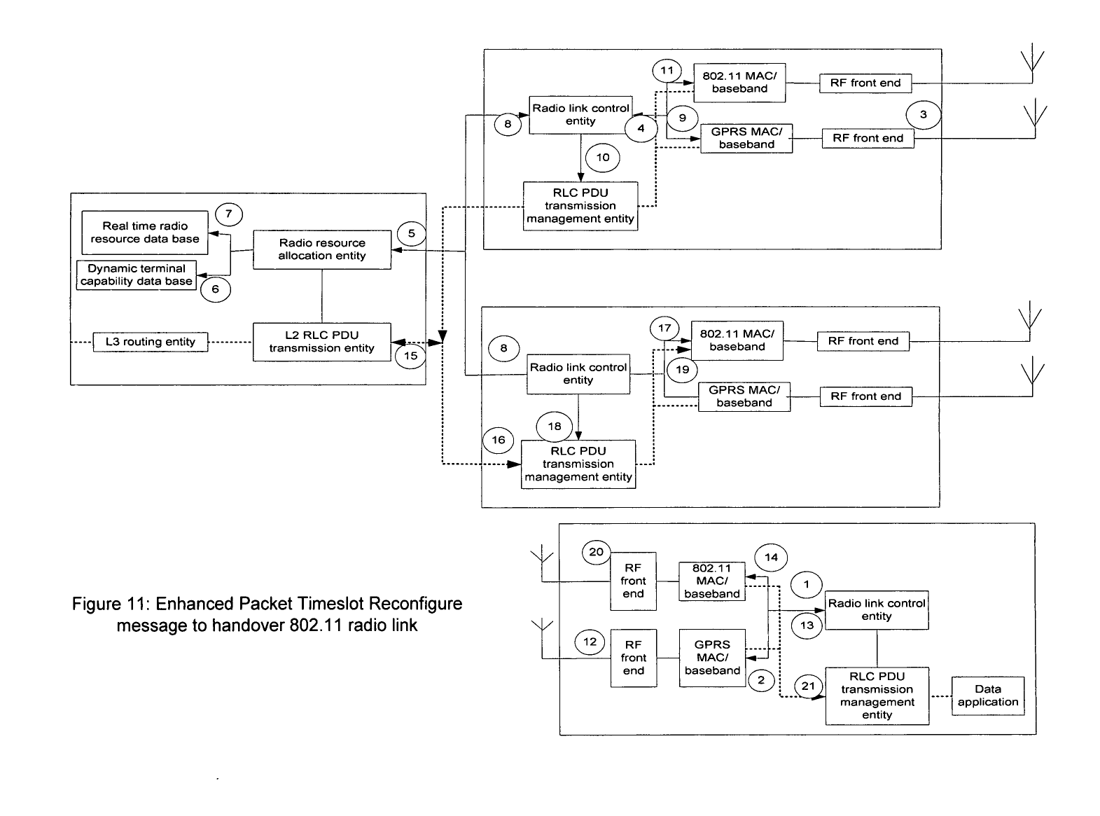

Refer to FIG. 11, during downlink 802.11 frame transmissions, over a period of time, if the terminal 802.11 module detects the serving AP signal to noise ratio (SNR) keep deteriorating, it will report to the terminal radio link control entity \textcircled{1}. Terminal radio link control entity will report to AP radio link control entity through GPRS control channel \textcircled{2}. Upon AP GPRS transceiver received \textcircled{3}, the report will be forwarded to AP radio link control entity \textcircled{4}. The AP radio link control entity will try to raise the transmission power. If still the problem exists, the AP radio link control entity will report to radio resource allocation entity \textcircled{5}, which will decide whether to handover the 802.11 radio link to another AP. If yes, the radio resource allocation entity will query dynamic terminal capability data base for the specific terminal capability \textcircled{6}, query the real time radio resource data base for available radio resource and AP geo-location \textcircled{7}, and determine a new serving access point. The radio resource allocation entity will compose a specific packet time slot reconfiguration message; send to current serving AP and new AP radio link control entity \textcircled{8}. The composed specific packet time slot reconfiguration message include one or more of the information elements comprise new access point, frequency, channel bandwidth, coding scheme, modulation, initial transmission power, 802.11 frame transmission restart time aligned with GPRS control frame, etc.

Upon the specific packet time slot reconfiguration message being received, the current serving AP radio link control entity will forward it to the terminal radio link control entity through GPRS control channel \textcircled{9}. Upon the specific packet time slot reconfiguration message being sent, the current serving AP radio link control entity will instruct the RLC PDU management entity to suspend the RLC PDU transmission, inform L2 RLC PDU transmission entity to redirect the incoming RLC PDU \textcircled{10}, suspend the current 802.11 frame transmissions, and turn off the 802.11 radio module \textcircled{11}. When the specific packet time slot reconfiguration message received by the terminal GPRS transceiver \textcircled{12}, it will be forwarded to the terminal radio link control entity \textcircled{13}. The terminal radio link control entity will turn off the 802.11 radio module, configure the 802.11 transceiver accordingly, and turn on 802.11 radio module, ready to receive from the new radio link downlink 802.11 frames \textcircled{14}. Upon the redirect information received from the current serving AP RLC PDU transmission entity \textcircled{15}, the L2 RLC PDU transmission entity will redirect the incoming L2 RLC PDU to the new serving access point RLC PDU transmission entity \textcircled{16}. Upon the specific packet time slot reconfiguration message received, the new AP radio link control entity will configure the 802.11 transceiver accordingly \textcircled{17}. At the specified GPRS control frame, the new AP radio link control entity instruct the RLC PDU transmission management entity to start the RLC PDU transmission \textcircled{18}, turn on the 802.11 radio module, starts 802.11 frame transmission at the specified GPRS control frame time \textcircled{19}. Upon the 802.11 frames received from the new AP through the new radio link \textcircled{20}, the terminal 802.11 transceiver will forward them to the RLC PDU transmission management entity \textcircled{21}.

In case the 802.11 radio link handover failure or time out, the current serving AP radio link control entity will try to resume the original 802.11 radio link. If it fails, the AP radio link control entity will establish a GPRS TBF for continuous data communication.

We claim:

1. A method to schedule 802.11 channel as a QoS enabled GPRS high speed supplementary data channel comprising:
a. The enhanced specific GPRS TBF signaling message, specifically for 802.11 radio link establishment.
b. The enhanced specific packet time slot reconfiguration message, specifically for 802.11 radio link reconfiguration or handover
c. The specific TBF message to specify the 802.11 data frame transmission start time.
d. The specific packet time slot reconfiguration message to specify the 802.11 frame transmission restart time
e. The specific TBF procedure for 802.11 radio link establishment
f. The specific packet time slot reconfiguration procedure for 802.11 radio link reconfiguration or handover
g. 802.11 frame transmission start or restart time aligned with GPRS control frame
h. A radio link control unit coordinates the GPRS transceiver module and 802.11 transceiver module
i. The mechanism to encapsulate GPRS RLC PDUs into 802.11 MAC frame

2. The enhanced specific GPRS signaling message, as claimed in claim 1, comprises 802.11 radio link information as frequency, channel bandwidth, coding scheme, modulation, initial transmission power, 802.11 frame transmission start time aligned with GPRS control frame

3. The enhanced packet time slot reconfiguration message, as claimed in claim 1, comprises new 802.11 radio link information as new access point, frequency, channel bandwidth, coding scheme, modulation, initial transmission power, 802.11 frame transmission restart time aligned with GPRS control frame

4. The specific TBF for 802.11 data frame transmission, as claimed in claim 1, may coexist with GPRS TBF to support simultaneous 802.11 and GPRS data transmission.

5. The specific TBF establishment procedure, as claimed in claim 1, wherein the procedure has a fall back to GPRS TBF mechanism when the specific TBF establishment procedure for 802.11 radio link fails.

6. The specific packet time slot reconfiguration procedure for 802.11 radio link reconfiguration or handover, as claimed in claim 1, wherein the procedure has a fall back to GPRS TBF mechanism when the specific packet time slot reconfiguration procedure for 802.11 radio link reconfiguration or handover fails.

7. As claimed in claim 1, the 802.11 frame transmission start or restart time is aligned with GPRS control frame which is regularly calibrated by GPRS timing.

8. The specific TBF for 802.11 radio link, as claimed in claim 1, wherein the TBF duration is specified as numbers of GSM time slots or GSM frames.

9. The specific TBF for 802.11 radio link, as claimed in claim 1, wherein the TBF can be applied to unidirectional.

10. The specific TBF for 802.11 radio link, as claimed in claim 1, wherein the TBF can be applied to bi-directional.
